(19) United States
(12) Patent Application Publication
(10) Pub. No.: US 2013/0303183 A1
(43) Pub. Date: Nov. 14, 2013

(54) SYSTEM AND METHOD FOR POSITIONING USING MAP-ASSISTED KALMAN FILTERING

(71) Applicant: Mohamed Farouk MANSOUR, Richardson, TX (US)

(72) Inventor: Mohamed Farouk MANSOUR, Richardson, TX (US)

(73) Assignee: TEXAS INSTRUMENTS INCORPORATED, Dallas, TX (US)

(21) Appl. No.: 13/466,321

(22) Filed: May 8, 2012

(51) Int. Cl. G01S 3/02; H04W 24/00

(52) U.S. Cl. 455/456.1; 342/450

(57) ABSTRACT

Apparatus and method for positioning using map-assisted Kalman filtering. In one embodiment, a wireless device includes a positioning system configured to determine a position of the device based on wirelessly received positioning signals. The positioning system is configured to compute, via a Kalman filter, an initial location of the wireless device. The positioning system is also configured to determine whether the initial location is within a polygon defining a prohibited geographic area. The positioning system is further configured to identify an edge of the polygon nearest the initial location, based on the initial location being determined to be within the polygon. The positioning system is yet further configured to provide information defining the edge of the polygon to the Kalman filter as a measurement for use in computing a final position of the wireless device.

### BACKGROUND

As mobile devices proliferate, the demand for services tailored to device location also increases. Location based services depend on positioning systems to determine device location. Satellite based positioning systems, such as the global positioning system (GPS), GLONASS, and Galileo can provide high accuracy, but require a clear line of sight between the satellites and the mobile device to provide a position determination. Consequently, satellite positioning systems are largely ineffective for indoor positioning.

As an alternative or an augmentation to satellite based positioning, wireless local area network (WLAN) based positioning systems have been developed. WLAN based positioning systems are suitable for indoor positioning and require minimal investment because they make use of existing infrastructure. WLAN based positioning systems determine mobile device position based on the established positions of WLAN access points visible to the device and the strength of signals exchanged between the mobile device and the access points.

For satellite positioning systems, WLAN positioning systems, and positioning systems in general, improved positioning accuracy is desirable.

### SUMMARY

Apparatus and method for positioning using map-assisted Kalman filtering. In one embodiment a method for positioning includes computing, by a wireless device, via a Kalman filter, an initial location of the wireless device. Whether the initial location is within a polygon defining a prohibited geographic area is determined. Based on the initial location being determined to be within the polygon, an edge of the polygon nearest the initial location is identified.

In another embodiment, a wireless device includes a positioning system configured to determine a position of the wireless device based on wirelessly received positioning signals. The positioning system is configured to compute, via a Kalman filter, an initial location of the wireless device. The positioning system is also configured to determine whether the initial location is within a polygon defining a prohibited geographic area. The positioning system is further configured to identify an edge of the polygon nearest the initial location, based on the initial location being determined to be within the polygon.

In a further embodiment, a position measurement device includes positioning logic. The positioning logic includes a Kalman filter and a map. The Kalman filter is configured to generate estimates of the location of the device. The map defines prohibited geographic areas. The positioning logic is also configured to determine whether an initial estimated location generated by the Kalman filter is within a polygon of the map. The polygon defines a prohibited geographic area. The positioning logic is further configured to, based on the initial location being determined to be within the polygon, identify an edge of the polygon nearest the initial location, and provide information defining the edge of the polygon nearest the initial location to the Kalman filter. The positioning logic is yet further configured to cause the Kalman filter to generate a final location of the device based on the information defining the edge.

### BRIEF DESCRIPTION OF THE DRAWINGS

For a detailed description of exemplary embodiments of the invention, reference will now be made to the accompanying drawings in which:

FIG. 1 shows a block diagram of a system for determining the position of a wireless device based on map-assisted Kalman filtering in accordance with various embodiments;

FIG. 2 shows a block diagram of a mobile wireless device configured to perform positioning using map-assisted Kalman filtering in accordance with various embodiments; and

FIG. 3 shows a flow diagram for a method for positioning using map-assisted Kalman filtering in accordance with various embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. Further, the term “software” includes any executable code capable of running on a processor, regardless of the media used to store the software. Thus, code stored in memory (e.g., non-volatile memory), and sometimes referred to as “embedded firmware,” is included within the definition of software. The recitation “based on” is intended to mean “based at least in part on.” Therefore, if X is based on Y, X may be based on Y and any number of additional factors.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

A Kalman filter, or a variant thereof, such as an extended Kalman filter, may be included in a positioning device to provide position estimation. The Kalman filter generates a new position estimate based on previous position estimates and new positioning measurements. The positioning measurements can take the form of time-of-flight (TOF) to references with known position (e.g., in satellite positioning systems), Angle-of-Arrival (AOA) to geometrically distributed references (e.g., in Radar applications), strength of the received signal for known references as in wireless local area network (WLAN) positioning applications, etc.

Embodiments of the present disclosure provide improved positioning accuracy by incorporating a map into the positioning system and applying the map to refine position estimates. Embodiments incorporate map information into a Kalman filter. The Kalman filter generates improved position estimates based on the map information.

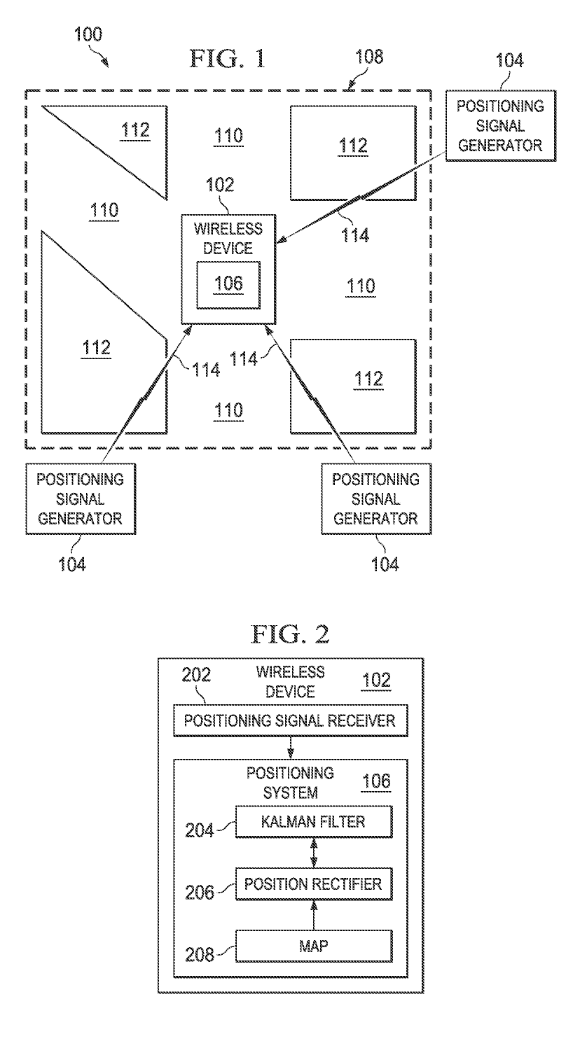

FIG. 1 shows a block diagram of a system 100 for determining the position of a wireless device based on map-assisted Kalman filtering in accordance with various embodiments. The system 100 includes a wireless device 102 and a plurality of positioning signal generators 104. The positioning signal generators 104 may be positioning satellites, WLAN access points, or any other device configured to generate signals usable by the wireless device 102 for position determination.

The wireless device 102 is positioned to receive transmissions from and/or communicate with the positioning signal generators 104. The wireless device 102 may be a satellite positioning system receiver, a cellular telephone, a tablet computer, or any other mobile computing device configured to perform positioning based on the signals received from the positioning signal generators 104. While only three positioning signal generators 104 and a single wireless device 102 are shown in FIG. 1, in practice the system 100 may include any number of wireless devices 102 and positioning signal generators 104.

The wireless device 102 is disposed in a geographic region 108. The geographic region 108 includes areas 110 in which the wireless device 102 may travel (i.e., permitted areas), and areas 112 in which the wireless device 102 may not travel (i.e., prohibited areas). For example, if the wireless device 102 includes a vehicle navigation receiver, the permitted areas 110 may include roadways, and the prohibited areas 112 may include buildings, parks, rivers, etc. Similarly, if the wireless device 102 includes an indoor pedestrian navigation system, then the permitted areas 110 may include aisles, hallways, waiting areas, etc., and the prohibited areas 112 may include office spaces, laboratories, etc.

The wireless device 102 includes a positioning system 106 that processes measurements of the positioning signals 114, and determines the location of the wireless device 102 based on the measurements. The positioning system 106 includes a Kalman filter that generates position estimates. The positioning system 106 also includes a map that defines the locations of the prohibited areas 112 of the geographic region 108 in which the wireless device 102 is operating. The Kalman filter applies information provided by the map that defines the prohibited areas 112 to improve positioning accuracy.

In some embodiments of the system 100, positioning signal generators 104 cooperate to determine the position of the device 102 based on signals reflected or generated by the device 102. In such embodiments, the positioning system 106 as described herein may be disposed in one or more of the positioning signal generators 104.

FIG. 2 shows a block diagram of a wireless device 102 configured to perform positioning using map-assisted Kalman filtering in accordance with various embodiments. The wireless device 102 includes a positioning signal receiver 202 and a positioning system 106. The positioning signal receiver 202 receives the positioning signals 114 transmitted by the positioning signal generators 104. For example, the positioning signal receiver 202 may a satellite signal receiver for reception of satellite positioning signals, a WLAN receiver for reception of access point transmissions used in WLAN positioning, or another type of receiver suitable for receiving signals used to determine the geographic position of a device. The positioning signal receiver 202 provides measurements derived from the received positioning signals 114 to the positioning system 106. The measurements may be, for example, TOF measurements, signal strength measurements, etc. The positioning signal receiver 202 may be separate from or integrated with the positioning system 106 in various embodiments of the wireless device 102.

The positioning system 106 generates position estimates based on the signal measurements provided by the positioning signal receiver 202. The positioning system 106 comprises positioning logic including a Kalman filter 204, a position rectifier 206, and a map 208. The Kalman filter 204 recursively estimates position based previous position estimates and fresh signal measurements. The state of the Kalman filter includes the (x, y, z) position of the wireless device 102. Kalman filter processing can be denoted as:

xₖ=Axₖ₋₁+Buₖ₋₁+wₖ₋₁ (1)

where:
xₖ is the state at time instant k;
A is the state transition matrix;
wₖ is the process noise at time instant k;
uₖ is an optional control input (not used in some embodiments of the Kalman filter 204); and
B is a matrix that relates the optional control input uₖ to the state x.

The Kalman filter 204 estimates the state based on measurements z described as:

zₖ=Hxₖ+vₖ (2)

where:
zₖ is the measurement (vector in general) at time instant k;
vₖ is the measurement noise at time instant k; and
H is a matrix that relates the state x to the measurement z. The matrix H is also called the sensitivity matrix.

The covariance matrix of wₖ is denoted Qₖ and called the process noise covariance. The covariance matrix of vₖ is denoted Rₖ and called the measurement noise covariance.

The Kalman filter 204 provides an estimate \hat{x}ₖ of the state, based on the present measurement zₖ and all past measurements. The estimation is performed in two steps—first, an apriori estimate \hat{x} _{k̅} is computed based on the previous state estimate and the state transition model, and then, the aposteriori estimate \hat{x}ₖ is computed which includes the present measurement.

The Kalman filter therefore has two sets of equations: the time update equations and the measurement update equations. The time update equations calculate the apriori state estimate \hat{x} _{k̅} and its error covariance matrix P _{k̅} as:

\hat{x} _{k̅}=A\hat{x}ₖ₋₁+Buₖ₋₁

P _{k̅}=APₖ₋₁A^{T}+Q

where:
Pₖ₋₁ the error covariance matrix of the state estimate at time k-1, i.e., Pₖ₋₁=E{(xₖ₋₁−\hat{x}ₖ₋₁)(xₖ₋₁−\hat{x}ₖ₋₁)^{T}}.

The measurement update equations calculate the aposteriori state estimate as:

Kₖ=P _{k̅}H^{T}(HP _{k̅}H^{T}+R)⁻¹

\hat{x}ₖ=\hat{x} _{k̅}+Kₖ(zₖ−H\hat{x} _{k̅})

Pₖ=(I−KₖH)P _{k̅}

The computation of the aposteriori estimate involves calculation of a Kalman Gain matrix denoted as Kₖ above, which is used in conjunction with the present measurement to update the apriori estimate. The error covariance matrix Pₖ is also recursively updated.

The map 208 includes information describing the geographic region 108 in which the wireless device 102 is operating. The geographic region 108 is decomposed into two disjoint subsets: the set of permissible areas 110, and the set of prohibited areas 112. In the map 208, the set of prohibited areas 112 may be modeled as a group of subsets each containing a contiguous set of points inside a polygon. The polygon is specified by a set of corners and lines (edges between adjacent corners). Thus, the map 208 may describe each prohibited area 112 as a polygon disposed at a known location. For example, the map 208 may define the locations of the corners of each prohibited area polygon.

The position rectifier 206 examines the location estimates produced the Kalman filter 204 in light of the map 208. More specifically, the position rectifier 206 determines whether a position estimate produced by the Kalman filter 204 locates the wireless device 102 within a polygon defining a prohibited area 112. Embodiments may apply any known method to determine whether the position estimate places the wireless device 102 within a polygon defining a prohibited area. Some embodiments of the position rectifier 206 apply ray casting to determine whether the position estimate places the wireless device 102 within a prohibited area 112. For example, if a ray emanating from the estimated position intersects an odd number of edges of a polygon (e.g., a convex polygon) defining a prohibited area 112, then the estimated position is within the prohibited area 112. If the ray intersects an even number of edges of the polygon, then the estimated position is not within the prohibited area 112. Some embodiments of the position rectifier 206 cast a ray parallel to the y-axis to simplify the determination.

If the position rectifier 206 determines that the estimated position generated by Kalman filter 204 is within a prohibited area 112, then the position rectifier 206 identifies the edge of the polygon that is nearest the estimated position, and provides information defining the edge to the Kalman filter 202. Using the edge information provided by the position rectifier 206, the Kalman filter 202 generates a new position estimate.

Various components of the wireless device 102 including at least some portions of the positioning system 106 can be implemented using a processor executing software programming that causes the processor to perform the operations described herein. In some embodiments, the positioning system 106 includes a processor executing software instructions that cause the processor to generate position estimates via Kalman filtering and to refine the position estimates using map information provided to the Kalman filter as described herein.

Suitable processors include, for example, general-purpose microprocessors, digital signal processors, and microcontrollers. Processor architectures generally include execution units (e.g., fixed point, floating point, integer, etc.), storage (e.g., registers, memory, etc.), instruction decoding, peripherals (e.g., interrupt controllers, timers, direct memory access controllers, etc.), input/output systems (e.g., serial ports, parallel ports, etc.) and various other components and sub-systems. Software programming (i.e., processor executable instructions) that causes a processor to perform the operations disclosed herein can be stored in a computer readable storage medium. A computer readable storage medium comprises volatile storage such as random access memory, non-volatile storage (e.g., a hard drive, an optical storage device (e.g., CD or DVD), FLASH storage, read-only-memory), or combinations thereof. Processors execute software instructions. Software instructions alone are incapable of performing a function. Therefore, in the present disclosure any reference to a function performed by software instructions, or to software instructions performing a function is simply a shorthand means for stating that the function is performed by a processor executing the instructions.

In some embodiments, portions of the wireless device 102, including portions of the positioning system 106 may be implemented using dedicated circuitry (e.g., dedicated circuitry implemented in an integrated circuit). Some embodiments may use a combination of dedicated circuitry and a processor executing suitable software. For example, some portions of the positioning system 106 may be implemented using a processor or hardware circuitry. Selection of a hardware or processor/software implementation of embodiments is a design choice based on a variety of factors, such as cost, time to implement, and the ability to incorporate changed or additional functionality in the future.

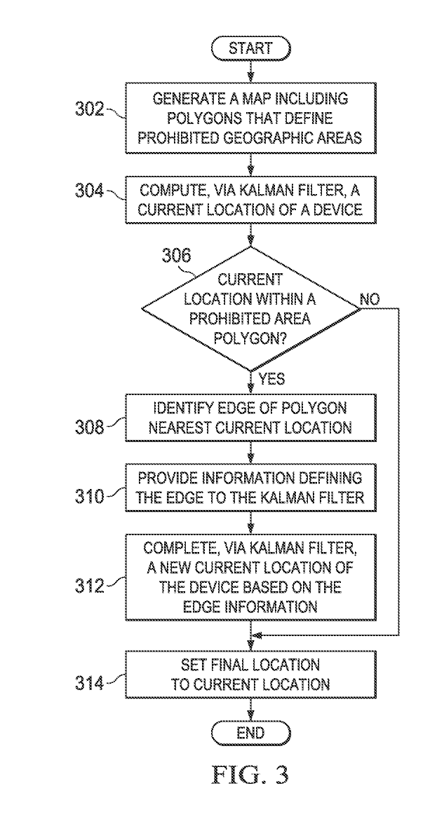

FIG. 3 shows a flow diagram for a method 300 for positioning using map-assisted Kalman filtering in accordance with various embodiments. Though depicted sequentially as a matter of convenience, at least some of the actions shown can be performed in a different order and/or performed in parallel. Additionally, some embodiments may perform only some of the actions shown. The operations of the method 300 can be performed by the positioning system 106. In some embodiments, at least some of the operations of the method 300, as well as other operations described herein, can be performed by a processor of the positioning system 106 executing instructions stored in a computer readable storage medium.

In block 302, a map 208 is generated. Geographic areas within which the wireless device 102 is allowed to travel are identified, and geographic areas within which the wireless device 102 is not allowed to travel are identified (i.e., prohibited areas 112). In the map 208, the prohibited areas 112 are defined as polygons. Each prohibited area polygon is defined by its corners and its edges. Each edge may be defined as a line equation of the form: y=mx+c. The map 202 may be stored within the wireless device 102, or stored outside the wireless device 102, on a server for example, and accessed via a network or other communication mechanism.

In block 304, the wireless device 102 is receiving positioning signals 114. The wireless device computes, via, a Kalman filter 204, a current position estimate for the wireless device 102. The Kalman filter 204 generates the position estimate based on previous position estimates and newly received measurement values derived from the received positioning signals.

In block 306, the wireless device 102 determines whether the current position estimate places the wireless device 102 within any of the prohibited area polygons defined by the map 208. If the current position estimate places the wireless device 102 outside of each prohibited area polygon (i.e., the current position estimate places the wireless device in a permitted area), then, in block 314, the current position estimate is deemed to be a final position estimate for the wireless device 102.

On the other hand, if the current position estimate places the wireless device 102 within a prohibited area polygon, then, in block 308, the wireless device 102 measures the distance between the current position and each edge of the encompassing polygon. The wireless device may measure the distance to each edge by projecting a point corresponding to the current position onto the line representing each edge. Based on the distance measurements, the wireless device identifies the edge of the polygon nearest the current position.

In block 310, the wireless device 102 provides the equation (y=mx+c) for the line corresponding to the edge nearest the current position to the Kalman filter 204 as a measurement. The measurement value is the constant c , and the corresponding measurement matrix (H in equation (2)) is all zeros except for the first two entries (which are multiplied by x and y respectively) which respectively have the values of: −m and 1. The measurement noise covariance matrix Rₖ is set to an arbitrary small value.

In block 312, the wireless device 102 computes, via, the Kalman filter 204, a refined current position estimate for the wireless device 102. The Kalman filter 204 generates the refined current position estimate based on the measure value identifying the edge of the prohibited area polygon nearest the previously generated position estimate.

In block 314, the refined current position estimate, based on information provided from the map 208, is deemed to be the final position estimate for the wireless device 102.

The above discussion is meant to be illustrative of the principles and various embodiments of the present invention. Numerous variations and modifications will become apparent to those skilled in the art once the above disclosure is fully appreciated. For example, in some embodiments, the positioning system 106 or components thereof, may be located remote from the wireless device 102 and accessed via a wireless network. In such a system, the remote positioning system/device 106 may receive signal measurements and the like from the wireless device 102 via a wireless network, determine the position of the wireless device 102 as disclosed herein, and provide position information to the wireless device 102 via the wireless network. It is intended that the following claims be interpreted to embrace all such variations and modifications.

1. A method for positioning, comprising:
receiving transmissions from a positioning signal generator;
generating a map, the map comprising a set of polygons, each polygon of the set defining a prohibited geographic area;
computing, by a positioning device, via a Kalman filter, an initial location of a wireless device;
determining, by accessing the map, whether the initial location is within the prohibited geographic area; and
identifying, by the positioning device, an edge of the polygon nearest the initial location, based on the initial location being determined to be within the polygon.

2. The method of claim 1, further comprising:
providing information defining the edge of the polygon nearest the initial location to the Kalman filter; and
computing, by the positioning device, via the Kalman filter, a final location of the wireless device based on the information defining the edge.

3. The method of claim 2, wherein the information comprises a slope-intercept equation of a line on which the edge lies.

4. The method of claim 1, further comprising deeming the initial location to be a final location of the wireless device, based on the initial location being not within any polygon defining a prohibited geographic area.

5. (canceled)

6. The method of claim 1, wherein the identifying comprises measuring distance between the initial location and each edge of the polygon.

7. The method of claim 1, wherein the determining comprises:
determining whether the polygon is convex, and based on the polygon being convex:
projecting a ray from the initial location; and
determining that the initial location is within the polygon based on the ray intersecting an odd number of edges of the polygon.

8. The method of claim 1, further comprising:
measuring parameters of positioning signals wirelessly received by the wireless device; and
providing the measured parameters to the Kalman filter for use in the computing.

9. A wireless device, comprising:
a positioning system configured to determine a position of the device based on wirelessly received positioning signals, wherein the positioning system comprises a map, the map comprising a set of polygons, each polygon defining a prohibited geographic area; and the positioning system is configured to access the map to determine whether an initial location is within a polygon defining a prohibited geographic area, the positioning system configured to:
compute, via a Kalman filter, the initial location of the wireless device;
determine whether the initial location is within the prohibited geographic area; and
identify an edge of the polygon nearest the initial location, based on the initial location being determined to be within the polygon.

10. The wireless device of claim 9, wherein the positioning system is configured to:
provide information defining the edge of the polygon nearest the initial location to the Kalman filter; and
compute, via the Kalman filter, a final location of the wireless device based on the information defining the edge.

11. The wireless device of claim 10, wherein the information comprises a slope-intercept equation of a line on which the edge lies.

12. The wireless device of claim 9, wherein the positioning system is configured to deem the initial location to be a final location based on the initial location being not within any polygon defining a prohibited geographic area.

13. (canceled)

14. The wireless device of claim 9, wherein the positioning system is configured to measure distance between the initial location and each edge of the polygon.

15. The wireless device of claim 9, wherein the positioning system is configured to:
project a ray from the initial location; and
determine that the initial location is within the polygon based on the ray intersecting an odd number of edges of the polygon.

16. The wireless device of claim 9, wherein the wireless device is configured to:
measure parameters of wirelessly received positioning signals; and
provide the measured parameters to the Kalman filter for use in location computing.

17. A position measurement device, comprising:
positioning logic, comprising:
a Kalman filter that generates location estimates; and
a map that defines prohibited geographic areas;
wherein the positioning logic is configured to:
receive transmissions from a positioning signal generator;
determine whether an initial estimated location generated by the Kalman filter is within a polygon of the map, wherein the polygon defines a prohibited geographic area; and
based on the initial estimated location being determined to be within the polygon:
identify an edge of the polygon nearest the initial estimated location;
provide information defining the edge of the polygon nearest the initial estimated location to the Kalman filter; and
cause the Kalman filter to generate a final location estimate based on the information defining the edge.

18. The position measurement device of claim 17, wherein the information comprises a slope-intercept equation of a line on which the edge lies.

19. The position measurement device of claim 17, wherein the positioning logic is configured to deem the initial estimated location to be the final location estimate, based on the initial estimated location being not within any polygon defining a prohibited geographic area found in the map.

20. The position measurement device of claim 17, wherein the positioning logic is configured to measure distance between the initial estimated location and each edge of the polygon based on the initial estimated location being determined to be within the polygon.

21. The position measurement device of claim 17, wherein the positioning logic is configured to:
project a ray from the initial estimated location; and
determine that the initial estimated location is within the polygon based on the ray intersecting an odd number of edges of the polygon.

22. The position measurement device of claim 17, further comprising:
a wireless receiver configured to:
measure parameters of wirelessly received positioning signals; and
provide the measured parameters to the Kalman filter for use in generating location estimates.
